(19) United States
(12) Patent Application Publication
(10) Pub. No.: US 2010/0239809 A1
(43) Pub. Date: Sep. 23, 2010

(54) MATTING

(75) Inventors: Thomas Langley Sutherland, Stranraer (GB); William Burns, Stranraer (GB)

Correspondence Address: SNELL & WILMER L.L.P. (Main), 400 EAST VAN BUREN, ONE ARIZONA CENTER, PHOENIX, AZ, 85004-2202, US

(73) Assignee: CALEDONIA MATTING LIMITED, Stranraer (GB)

(21) Appl. No.: 12/664,339

(22) PCT Filed: Jun. 16, 2008
(86) PCT No.: PCT/GB2008/002051

§ 371 Date: Jun. 4, 2010

(30) Foreign Application Priority Data
Jun. 15, 2007 (GB) 0711634.6

(51) Int. Cl. B32B 3/06

(52) U.S. Cl. 428/99

(57) ABSTRACT

A mat assembly comprises a number of tiles adapted to be coupled together to define a substantially continuous tread surface. Each tile comprises a base 12 comprising a number of upstanding strips 14 which extend across the tile 10. Scraper strips 18 are provided in channels 16 defined between the base 12 and the upstanding strips 14, the scraper strips 18 adapted to scrape or brush material, for example, dirt, fluid and the like from the shoes of people entering a building, thereby trapping this material and preventing it from being tracked into the building.

### FIELD OF THE INVENTION

This invention relates to improved matting and, in particular, but not exclusively, to a matting tile and mat assembly for use as entrance matting, barrier matting or the like.

### BACKGROUND TO THE INVENTION

Entrance matting is typically provided at the entrances and/or exits of buildings, such as shops, offices, or the like to assist in the removal of dirt and/or fluid from the footwear of people entering the building and to assist in preventing such material from being carried or tracked through the building. The volume of dirt and fluid entering the building will vary, for example, according to the environmental conditions found outside the building and the volume and direction of traffic over the matting.

Matting may thus be used to clean and, where appropriate, dry foot traffic as it enters the building, the dirt and/or fluid being held on or within the matting surface. In addition to assisting in the maintenance of the appearance of flooring within the building, the use of entrance matting may also reduce the risk of slipping on the floor surfaces.

It will be recognised that while it is beneficial to hold the trapped material in the matting, the material must be removed regularly to prevent further tracking into the building.

European Patent EP 0 841 872 B, which is incorporated herein in its entirety by way of reference, provides an entrance mat comprising a number of upstanding strips, the strips defining channels therebetween. Carpet strips are provided in the channels to provide a scraping surface for use in removing dirt and moisture from the footwear of people entering a given building. Transverse grooves are provided in a lower layer of the mat, the transverse grooves adapted to intersect the channels of the mat surface to transport fluid away from the mat surface, permitting the mat surface to dry out. Such an arrangement may assist in maintaining performance of the mat and may extend the working life of the mat.

### SUMMARY OF THE INVENTION

According to a first aspect of the present invention there is provided a matting tile for use in a mat assembly, the tile comprising:

a base comprising at least one upstanding strip;

a plurality of channels adapted to permit fluid to drain from the tile;

a scraper arrangement located in the channels, the at least one upstanding strip and the scraper arrangement defining a substantially continuous tread surface; and

a connector for coupling the tile to at least one other tile.

According to a second aspect of the present invention there is provided a mat assembly for providing an entrance mat, the mat assembly comprising:

a plurality of tiles adapted to be coupled together, each tile comprising:

a base comprising at least one upstanding strip;

a plurality of channels adapted to permit fluid to drain from the tile;

a scraper arrangement located in the channels, the at least one upstanding strip and the scraper arrangement defining a substantially continuous tread surface; and

a connector for coupling the tile to at least one other tile.

The matting is adapted to provide a substantially continuous tread surface arranged to trap or otherwise capture dirt and/or fluid from traffic passing over the tread surface. This facilitates a passive cleaning action on the footwear of people entering the building in addition to any active scrubbing action initiated by a person walking over the matting.

The connector may be of any suitable form. For example, each tile may comprise at least one male connector member and, in particular embodiments, the male connector member may comprise a tongue, prong or the like. Alternatively, or in addition, each tile may comprise at least one female connector member and, in particular embodiments, the female connector member may comprise a slot, groove or the like. The male connector member and female connector member may be adapted to snap-fit or press-fit together, though it will be understood that any suitable connector may be used.

Accordingly, a number of tiles may be coupled together to form a matting surface of any required area and shape. This provides the advantage over a single mat surface in that it obviates or mitigates the requirement to cut the mat to size on site, reducing installation time. The matting may be provided in combination with a mat well, tray or the like and the well may be mounted into, or provided in, a ground or flooring surface at the entrance of the building. At least one tile may be adapted to engage, or be coupled to, the mat well.

The tiles may be removably coupled together. For example, it will be recognised that some areas of matting may experience higher traffic than other areas such that these higher traffic areas will become worn, requiring the matting to be replaced or removed. Thus, matting according to embodiments of the present invention may permit relatively small areas of the tread surface, for example, but not exclusively, areas which experience the highest traffic over their surface, to be removed for cleaning or replacement. This obviates the requirement to remove the entire tread surface where only a limited area of the tread surface has been damaged or worn. Alternatively, the tiles may be permanently coupled together, for example, but not exclusively, by a suitable adhesive, connector or the like.

In use, fluid, for example precipitation water, including fluid-borne dirt, may be removed and transported away from the tread surface into the channels, retaining the appearance of the matting and preventing the water from gathering or collecting on the tread surface. Fluid trapped by the scraper arrangement may also be directed to the channels and may be permitted to drain from the tile such that the tile maintains the ability to clean in wet conditions.

The, or each, tile may further comprise an upstanding rim extending around the periphery of the tile. Beneficially, the peripheral rim permits the tiles to abut an adjacent tile or, where applicable, the well. The rim may assist in preventing the tiles from overlapping each other to provide a substantially rigid and stable tread surface. Thus, where previously an intersection between areas of carpet or matting may represent a weak point, the intersection, for example, becoming frayed or disjointed resulting in a tripping hazard, the upstanding rim may provide a uniform, clean edge, enhancing the appearance of the matting and obviating or at least mitigating any tripping hazard to users of the mat. Furthermore, the rim may be used to accurately align a tile with the well or with an adjacent tile. The rim may be adapted to engage or be coupled to the mat well.

The channels may be defined by the base, the at least one upstanding strip and the upstanding rim. Each channel may comprise at least one aperture for drainage of fluid therethrough. In particular embodiments, a number of drainage apertures may be provided in each channel. Thus, fluid may be directed to the drainage apertures to drain from the matting. Fluid may not be permitted to rest on the surface of the matting, retaining the appearance of the mat and preventing trapped dirt from being released to track into the building. In particular embodiments, the aperture, or apertures, may be provided at an edge of the channel and adjacent to the at least one upstanding strip, thereby facilitating transfer of fluid from the upstanding strip and scraper arrangement through the aperture.

The, or each, upstanding strip may comprise, on an upper surface, ridges or grooves to direct fluid into the channels to be drained from the tile. The ridges/grooves may comprise a chevron form, a criss-cross form or other suitable form. In particular embodiments, the upstanding strip grooves may be orientated substantially transversely to the orientation of the carpet strips. In this way, fluid deposited between the scraper strips may be directed towards the channels and may be permitted to drain from the matting via the drainage apertures. The grooves may provide further areas for scraping dirt or the like from traffic passing over the matting.

The tile may further comprise at least one downward projecting rib on an underside of the tile, for example, but not exclusively, extending parallel to the predominant direction of traffic over the matting. Alternatively, the, or each, rib may extend perpendicularly or at an angle to the predominant direction of traffic over the matting, where appropriate. The, or each, rib may comprise a channel or profile which assists in providing structural rigidity to the tile. Furthermore, the profile may assist in removal of fluid, for example, by permitting air to circulate through the profile, resulting in evaporation.

The tile may further comprise at least one other rim extending around at least a portion of the periphery of the tile. For example, the tile may further comprise a downward projecting rim extending around the periphery of the tile. The downwards projecting peripheral rim of a first tile may be adapted to abut the downwards projecting peripheral rim of at least one adjacent tile on assembly. The female connection member may be formed in the downwards projecting peripheral rim and the tile may be configured such that when the rims are abutted, the male connection member may engage the female connection member to secure the tiles together, for example via a snap-fit connection, press-fit connection or the like.

The downwards projecting rim may comprise at least one slot for permitting fluid communication therethrough, facilitating drainage of fluid from the tile.

Each tile may comprise a single component. Alternatively, the tile may comprise a number of separate components coupled together. The provision of separate components may permit each component to be tailored to the operational or mechanical requirements of that component. For example, the tile may be formed into, or provide mounting for, at least one of: the upstanding strip; the scraper arrangement; the upstanding peripheral rim; downwards projecting peripheral rim; and downwards projecting rib. In particular embodiments, the tile may provide mounting for the at least one upstanding strip, the at least one upstanding strip adapted to be permanently or removably coupled to the tile, for example, but not exclusively, by a naplock arrangement, snap-fit connection, mechanical connector, adhesive or the like, though any suitable connection may be used where appropriate.

Alternatively, or in addition, the scraper arrangement may be formed in, or adapted for location in, the channels.

The scraper arrangement may comprise any arrangement suitable for suitable for removing dirt, moisture or the like. In particular embodiments, the scraper arrangement may comprise scraper strips. For example, the scraper strips may comprise carpet strip or the like. Alternatively, the scraper strips may comprise a brush, prongs, for example plastic moulded protrusions or any other arrangement suitable for removing dirt, moisture or the like. The scraper strips may be adapted to brush or otherwise scrape material such as dirt and/or fluid from the soles of people's feet as they walk over the matting.

The scraper strips may be arranged such that the strips are orientated substantially perpendicularly to the predominant direction of traffic over the matting.

Accordingly, the strips may assist in removal of dirt, fluid or the like. For example, where more than one tile is provided, the tiles may be orientated such that the scraper strips on adjacent tiles are orientated parallel to each other. The provision of parallel scraper strips is particularly advantageous in areas of uni-directional traffic over the tiles. Alternatively, where more than one tile is provided, the tiles may be arranged such that the strips are orientated substantially perpendicularly to each other to permit scraping in areas of varying or multi-directional traffic over the matting surface. Thus, one or more tiles may be adapted to removed dirt from traffic in a first direction and one or more second tile may be orientated to remove dirt from traffic in a second, different direction. Advantageously, a tiled arrangement permits the tread surface to comprise areas of predominantly uni-directional coverage and areas of multi-directional traffic within the overall tread surface. Thus, the matting may be tailored to meet the operational demands of the matting. Furthermore, should the demands on the matting vary over time, then the provision of male and female connection members permits individual tiles or a number of tiles to be removed periodically and adapted to meet the required operational demands.

The tile may be manufactured, for example, but not exclusively, from a thermoplastic elastomer, rubber, PVC or the like, though any suitable material may be used where appropriate. The colour, pattern or design of the tile may be selected to compliment the insignia, logos, or brand identity of the shop, building or site where the matting is to be installed. Thus, the use of a tiled matting assembly permits a high degree of flexibility and permits, for example, multiple colours to be used in the appearance of the matting without the requirement for cutting the matting.

### BRIEF DESCRIPTION OF THE DRAWINGS

These and other aspects of the present invention will now be described, by way of example, with reference to the accompanying drawings, in which:

FIG. 1 is a plan view of a matting tile in accordance with an embodiment of the present invention;

FIG. 2 is a sectional view of the matting tile of FIG. 1; and

FIG. 3 is a view of the matting tile of FIGS. 1 and 2 shown from below.

### DETAILED DESCRIPTION OF THE DRAWINGS

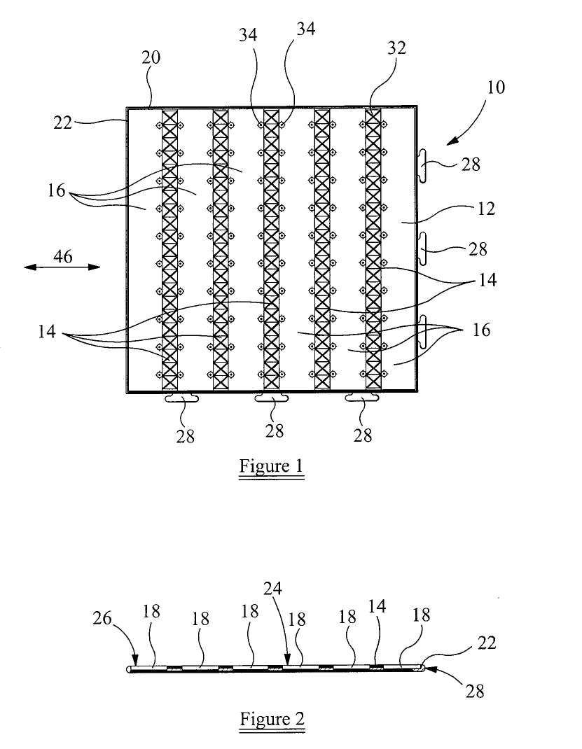

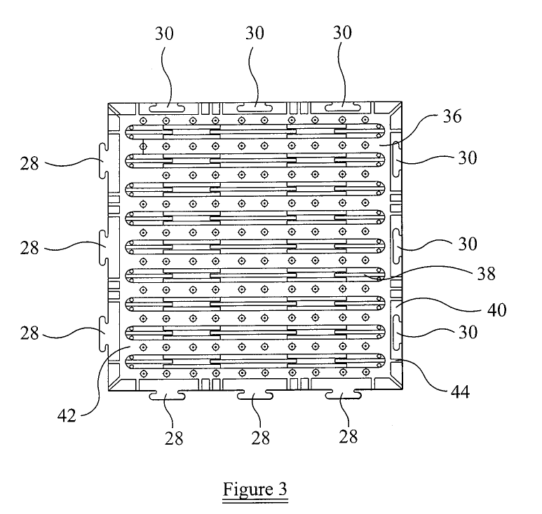

In reference initially to FIGS. 1 and 2 of the drawings, there is shown a plan view and side sectional view, respectively, of a matting tile 10 for use in a matting assembly according to an embodiment of the present invention.

The tile 10 comprises a generally planar, square first surface or base 12, the base 12 comprising a number of upstanding strips 14 extending longitudinally across the tile 10. The upstanding strips 14 are generally rectangular in shape, though the strips 14 need not be limited to this shape.

The base 12 and upstanding strips 14 together define channels 16 for receiving carpet strips 18, the carpet strips 18 adapted to scrape or brush material, for example, dirt, fluid, from the shoes of people entering a building (not shown), thus trapping this material and preventing it from being tracked into the building. Fluid, for example, precipitation, may also be removed and is directed into the channels 16 by the upstanding strips 14.

The channels 16 are generally rectangular in shape and the edges of the channels 16 formed by the upstanding strips 14 are of substantially trapezoidal form to further assist in directing fluid into the channels 16. Such a trapezoidal form is also advantageous in the manufacture of the tile 10, for example, as this provides a draft angle which assists in removing the tile 10 from a mould.

The base 12 further comprises an upstanding rim 20 located around the periphery of the tile. The peripheral rim 20 is provided with a chamfered edge 22 to further assist in directing fluid from the tile 10. The provision of the peripheral rim 20 and chamfered edge 22 is also considered to enhance the appearance of the matting.

With reference particularly to FIG. 2 of the drawings, the upstanding strips 14, peripheral rim 20 and carpet strips 18 together define an upper surface or tread surface 24 of the tile 10, the tread surfaces 24 of the tiles 10 forming a substantially continuous surface 26 on which to walk.

As may be seen from FIG. 3 of the drawings, the base 12 comprises outwardly projecting male connection members in the form of tongues 28 and comprises female connection members in the form of grooves 30. The tongues 28 and grooves 30 are provided in the base 12 such that, in use, the tongues 28 are adapted to engage the female grooves 30 of one or more adjacent tile (not shown) to form the continuous surface 26 of the required area. The provision of inter-engaging tongues 28 and female grooves 30 permits the peripheral rim 20 of the tile 10 to abut the rim 20 of an adjacent tile to provide the substantially continuous tread surface 26. In the illustrated embodiment, the tile 10 is generally square in shape and comprises tongues 28 on two edges and comprises grooves 30 on the remaining two edges. However, it will be recognised that the tile 10 may be of any shape and that any number of connection members 28, 30 may be provided, as appropriate.

The upstanding strips 14 comprise grooves 32 which further assist in removing dirt and fluid. The grooves 32 have a gradient, that is they are slightly convex, which assists in directing fluid, for example rain or snow, into the channels 16. In the illustrated embodiment, the grooves 32 comprise a chevron form. The provision of grooves 32 on the upstanding strips 14 also assists in providing a non-slip surface 26 which is safe to walk across, even in wet or icy conditions.

The tile 10 further comprises a number of drainage apertures or holes 34 provided in the channels 16, the holes 34 permitting fluid to drain from the channels 16. Each channel 16 comprises one or more drainage holes 34 so that fluid can drain from the tile 10. This prevents the tile 10 from becoming saturated even in wet conditions. As can be seen from FIGS. 1 and 3, the holes 34 are generally circular in shape, though it will be understood that any suitable shape of drainage hole 34 may be used.

With further reference to FIG. 3, a lower surface 36 of the base 12 comprises downwardly projecting ribs 38 extending across the tile 10 and a peripheral rim 40 extending around the perimeter of the tile 10. The provision of ribs 38 and rim 40 assists in providing structural rigidity to the tile 10. The ribs 38 comprise profiles which further assist in providing structural rigidity to the tile 10 and further assist in removal of fluid by permitting air to circulate around the lower surface 36 resulting in evaporation of fluid.

The ribs 38 are orientated perpendicularly to the channels 16 of the base 12. The female grooves 30 which are used to couple tiles 10 together are moulded or otherwise formed in the peripheral rib 40 and it will be recognised that the height of the rib 40 corresponds to the height of the tongues 28 provided in the base 12.

The upstanding ribs 38 and rim 40 together define channels 42 in communication with the drainage holes 34, the provision of these channels 42 permitting fluid to be collected from the drainage holes 34 and then directed to a drain (not shown). The provision of channels 42 assists in directing fluid, for example precipitation away from the drainage hole 34 and fluid collected in the channels 42 drains away or is directed away from the tile 10 through slots 44 cut or formed in the peripheral ribs 40. Where drainage is poor or restricted, the channels 42 and slots 44 permit a relatively large volume of water to be drained, where otherwise the holes 34 may become full of water resulting in backflow of fluid.

The tile 10 is formed from a flexible, resilient and hard-wearing material such as a thermoplastic elastomer, rubber, PVC or the like such that the tile 10 is relatively lightweight and can conform to irregular, uneven or sloping surfaces, where necessary. The material also provides high abrasion resistance, colour and UV stability, that is maintains colour over time, resistance from fungal growth, ozone and weather resistance. The material is also suitable for recycling after use. Such a material is suitable for mass production of the tile 10 by, for example, injection moulding, extrusion or the like.

In use, the carpet strips 18 may be orientated transversely to the predominant direction of traffic over the tile (shown by arrow 46) so as to provide a series of scraping surfaces to prevent dirt, fluid and the like from tracking through the building. The provision of carpet strips 18 permits the tile 10 to provide a repeated scraping action as, for example, a shoe walks over or is dragged across the tread surface 24. Though it is preferred that the carpet strips 18 are orientated transversely to the predominant direction of traffic 46, it will be understood that any orientation of the carpet strips 18 may be used. The use of a tiled arrangement permits tiles 10 to be orientated in different directions, for example, perpendicular to each other, thus providing a scraping action in many different directions. This is particularly advantageous where the matting is subject to multi-directional traffic over the tread surface 24.

The carpet strips 18 are formed from pile 30 (40/60 nylon/polypropylene) fixed in an impermeable PVC backing. However, it will be recognised that any suitable scraper strip or carpet material may be utilised, where necessary. Also, different scraper materials may be used in the same tile 10. Alternatively, or in addition, different scraper materials may be used in different tiles 10 such that the overall tread surface 24 comprises various scraping capabilities, this permitting the operation of the tiles 10 to be tailored to the operational requirements of the respective building or site.

The carpet strips 18 are slightly narrower than the channels 16 such that water can drain between the respective carpet strip 18 and channel 16 to drain from the tile 10. It has been found that larger particles of dirt are thus prevented from being carried into the channels 16 to block the drainage holes 34. The carpet strips 18 are secured within the channels 16 by an adhesive, double-sided tape or other suitable securement.

The tile 10 is adapted to be located in a tray or well (not shown), the well comprising a drain or outlet (not shown) to direct fluid to a drain or container.

Thus, in use, one or more tiles 10 are mounted within the well, the tile or tiles 10 arranged to abut the edges of the well. The provision of the peripheral rim 20 assists in securing the tile 10 or tiles 10 within the well. The tile 10 or tiles 10 may alternatively or additionally be secured within the well and, where appropriate, a relatively small gap is also provided between the tile 10 and the well such that fluid may be readily directed between the tile 10 and the well to drain. Where a number of tiles 10 are provided, these are coupled together via the tongues 28 and grooves 30, the tiles 10 being arranged in an overlapping manner such that the rim 20 of the tile 10 abuts the rim 20 of the adjacent tile. The tile 10 is configured such that when the rims 20 are abutted, the grooves 30 are located above the tongues 28 of the adjacent tile and may simply be pressed together to form the tread surface 26 of required area. As people walk over the surface 26, the soles of their footwear brush or scrape over the upper surface 24 of the or each tile 10, dirt thus being removed by the carpet strips 18 and prevented from tracking into the building. Also, fluid may be removed or trapped by the upstanding strips 14 and is directed into the channels 16 where it is drained from the tile 10 via the drainage holes 34. The fluid subsequently drains away or is directed away from the tile 10 via the lower surface channels 42 and slots 44.

It will be clear to those of skill in the art that various modifications and improvements may be made to the above-described embodiment without departing from the present invention.

For example, where necessary, one or more male connector member may be sheared, cut or otherwise removed from the tile when abutting the well.

Alternatively, the well may comprise connector members, for example, but not exclusively, female connector members, corresponding to the connectors of the or each tile to be coupled thereto. In this way, the well may advantageously be used to secure the relevant tile or tiles within the well to provide an attractive and clean edge to the matting.

1. A matting tile for use in a mat assembly, the tile comprising:
a base comprising at least one upstanding strip;
a plurality of channels adapted to permit fluid to drain from the tile;
a scraper arrangement located in the channels, the at least one upstanding strip and the scraper arrangement defining a substantially continuous tread surface; and
a connector for coupling the tile to at least one other tile.

2. A matting tile according to claim 1, comprising an upstanding rim extending around the periphery of the tile.

3. A matting tile according to claim 1, 2 or 3, wherein the channels are defined by the base, the at least one upstanding strip and the upstanding rim.

4. A matting tile according to claim 3, wherein at least one of the channels comprises at least one aperture to permit drainage of fluid therethrough.

5. A matting tile according to claim 4, wherein the at least one aperture is located adjacent to the edge of the channel.

6. A matting tile according to any preceding claim, comprising at least one downward projecting rib on an underside of the tile.

7. A matting tile according to claim 6, wherein the at least one downward projecting rib extends at an angle to the at least one upstanding strip.

8. A matting tile according to claim 6 or 7, wherein the at least one downward projecting rib extends substantially transversely to the at least one upstanding strip.

9. A matting tile according to any preceding claim, further comprising a downwards projecting rim extending around the periphery of the tile.

10. A matting tile according to claim 9, further comprising a plurality of channels defined by the downwards projecting rib and downwards projecting peripheral rim.

11. A matting tile according to claim 9 or 10, wherein the downwards projecting rim comprises at least one slot for permitting fluid communication therethrough.

12. A matting tile according to any preceding claim, wherein the connector comprises at least one male connector member.

13. A matting tile according to any preceding claim, wherein the connector comprises at least one female connector member.

14. A matting tile according to claims 9 to 15, wherein the female connector member is formed in the downwards projecting rim extending around the periphery of the tile.

15. A matting tile according to any preceding claim, wherein the tile is manufactured from at least one of a thermoplastic elastomer material; rubber material; and a PVC material.

16. A matting tile according to any preceding claim, wherein the tile comprises a plurality of components adapted to be coupled together.

17. A matting tile according to claim 16, wherein the scraper arrangement is adapted for location in channels.

18. A matting tile according to any one of claims 1 to 15, wherein the tile comprises a single component.

19. A matting tile according to claim 18, wherein the scraper arrangement is formed in the channels.

20. A matting tile according to any preceding claim, wherein the scraper arrangement comprises a scraper strip.

21. A matting tile according to claim 20, wherein the scraper strip comprises at least one of carpet strip; brushes; prongs; and moulded projections.

22. A matting tile according to any preceding claim, wherein the channels are of greater width than the at least one upstanding strip.

23. A matting tile according to any one of claims 2 to 22, wherein the upstanding strip is of greater width than the peripheral rim.

24. A matting tile according to any preceding claim, wherein the tile is substantially square.

25. A matting tile according to claim 24, wherein the tile has an area of about 0.25 square metres.

26. A mat assembly for providing an entrance mat, the mat assembly comprising:
a plurality of matting tiles adapted to be coupled together, each matting tile comprising:
a base comprising at least one upstanding strip;
a plurality of channels adapted to permit fluid to drain from the tile;
a scraper arrangement located in the channels, the at least one upstanding strip and the scraper arrangement defining a substantially continuous tread surface; and
a connector for coupling the tile to at least one other tile.

27. A mat assembly according to claim 26, wherein each tile comprises an upstanding rim extending the periphery of the tile.

28. A mat assembly according to claim 26, wherein the tiles are adapted to be coupled together such that upstanding rim of a tile abuts the upstanding rim of at least one adjacent tile.

29. A mat assembly according to claim 26, 27 or 28, wherein the tiles are adapted to be removably coupled together.

30. A mat assembly according to claim 26, 27, or 28, wherein the tiles are adapted to be permanently coupled together.

31. A mat assembly according to any one of claims 26 to 30, wherein the tiles are adapted to be coupled together such that the channels on a tile are orientated substantially parallel to the channels on at least one adjacent tile.

32. A mat assembly according to any one of claims 26 to 30, wherein the tiles are adapted to be coupled together such that the channels on a tile are orientated substantially perpendicular to the channels on at least one adjacent tile.
